(19) United States
(12) Patent Application Publication
(10) Pub. No.: US 2025/0259555 A1
(43) Pub. Date: Aug. 14, 2025

(54) AIRCRAFT MANAGEMENT SYSTEM AND AIRCRAFT MANAGEMENT METHOD

(71) Applicant: HONDA MOTOR CO., LTD., Tokyo (JP)

(72) Inventor: Yuho Yamazaki, Wako-shi (JP)

(21) Appl. No.: 19/024,743

(22) Filed: Jan. 16, 2025

(30) Foreign Application Priority Data
Feb. 14, 2024 (JP) 2024-019933

(51) Int. Cl. G08G 5/38; G08G 5/34; G08G 5/54; G08G 5/58

(52) U.S. Cl. CPC G08G 5/38; G08G 5/34; G08G 5/54; G08G 5/58

(57) ABSTRACT

An aircraft management system includes: a nearby available-for-landing port search unit configured to search for a nearby available-for-landing port located within a determination threshold distance from a route of the aircraft and able to accept a landing within a predetermined time after a route passing timing; and an alternative candidate port determination unit configured to, if the nearby available-for-landing port is extracted by the nearby available-for-landing port search unit, designate the extracted nearby available-for-landing port as an alternative candidate port for accommodating an emergency landing, or to, if the nearby available-for-landing port is not extracted, change the route of the aircraft to the destination point to a route in which a nearby available-for-landing port is extracted, and then designate the nearby available-for-landing port extracted for the changed route as the alternative candidate port.

### INCORPORATION BY REFERENCE

The present application claims priority under 35 U.S.C. § 119 to Japanese Patent Application No. 2024-019933 filed on Feb. 14, 2024. The content of the application is incorporated herein by reference in its entirety.

### BACKGROUND OF THE INVENTION

### Field of the Invention

The present invention relates to an aircraft management system and an aircraft management method.

### Description of the Related Art

A technique has been disclosed, which, as a precaution for a malfunction of an aircraft in flight, predetermines an alternative landing site to the original destination point and an alternative flight route, and thereby allows the malfunctioning aircraft to land at the alternative landing site (see, for example, U.S. Patent Application Publication No. 2022/0111962).

### SUMMARY OF THE INVENTION

The conventional system described above does not perform a process to check the current condition of an alternative landing site. Accordingly, when a malfunctioning aircraft attempts to land at a predetermined alternative landing site, the alternative landing site may not be available. In this case, inconveniently, the malfunctioning aircraft cannot land at the alternative landing site.

An object of the application, which has been made in consideration of such background, is to provide an aircraft management system and an aircraft management method that can prevent a situation in which an alternative landing site cannot be found for an aircraft in flight in the event of a malfunction of the aircraft, bad weather, or other contingent circumstances.

As a first aspect to achieve the aforementioned object, an aircraft management system is provided, which includes: a flight condition recognition unit configured to recognize a flight condition of an aircraft flying a route to a destination point; a nearby available-for-landing port search unit configured to recognize a route passing timing, which is a timing at which the aircraft flies the route, based on a result of recognizing the flight condition of the aircraft by the flight condition recognition unit, and to search for a nearby available-for-landing port, which is a takeoff/landing port located within a predetermined determination threshold distance from the route and able to accept a landing within a predetermined time after the route passing timing; and an alternative candidate port determination unit configured to, if the nearby available-for-landing port is extracted by the nearby available-for-landing port search unit, designate the extracted nearby available-for-landing port as an alternative candidate port for accommodating an emergency landing of the aircraft, or to, if the nearby available-for-landing port is not extracted by the nearby available-for-landing port search unit, change the route of the aircraft to the destination point to a route in which a nearby available-for-landing port is extracted by the nearby available-for-landing port search unit, and then designate the nearby available-for-landing port extracted by the nearby available-for-landing port search unit for the changed route as the alternative candidate port.

In the above aircraft management system, the flight condition recognition unit may be configured to repeatedly perform a process of recognizing the flight condition of the aircraft during a flight of the aircraft, the nearby available-for-landing port search unit may be configured to repeatedly perform a process of searching for a nearby available-for-landing port based on a result of recognizing the flight condition of the aircraft by the flight condition recognition unit, and the alternative candidate port determination unit may be configured to repeatedly perform a process of determining the alternative candidate port based on whether or not the nearby available-for-landing port is extracted by the nearby available-for-landing port search unit.

In the above aircraft management system, the flight condition recognition unit may be configured to recognize the flight condition including a level of a malfunction occurring in the aircraft, and the nearby available-for-landing port search unit may be configured to change the determination threshold distance according to the level of the malfunction occurring in the aircraft recognized by the flight condition recognition unit.

In the above aircraft management system, the flight condition recognition unit may be configured to recognize the flight condition including a remaining flyable range of the aircraft, and the nearby available-for-landing port search unit may be configured to change the determination threshold distance according to the remaining flyable range of the aircraft recognized by the flight condition recognition unit.

The above aircraft management system may include: a flight hindrance factor recognition unit configured to recognize presence or absence of a flight hindrance factor that hinders a flight of the aircraft to the destination point; and an emergency landing response unit configured to change the route of the aircraft to an emergency route to the alternative candidate port when the presence of the flight hindrance factor is recognized by the flight hindrance factor recognition unit.

The above aircraft management system may include an alternative transportation means information provision unit configured to provide information on alternative transportation means to travel from the alternative candidate port to a predetermined area in which the destination point is located, if the route of the aircraft is changed to an emergency route by the emergency landing response unit.

As a second aspect to achieve the aforementioned object, an aircraft management method executed by a computer is provided, which includes: a flight condition recognition step of recognizing a flight condition of an aircraft flying a route to a destination point; a nearby available-for-landing port search step of recognizing a route passing timing, which is a timing at which the aircraft flies the route, based on a result of recognizing the flight condition of the aircraft by the flight condition recognition step, and searching for a nearby available-for-landing port, which is a takeoff/landing port located within a predetermined determination threshold distance from the route and able to accept a landing within a predetermined time after the route passing timing; and an alternative candidate port determination step of, if the nearby available-for-landing port is extracted by the nearby available-for-landing port search step, designating the extracted nearby available-for-landing port as an alternative candidate port for accommodating an emergency landing of the aircraft, or, if the nearby available-for-landing port is not extracted by the nearby available-for-landing port search step, changing the route of the aircraft to the destination point to a route in which a nearby available-for-landing port is extracted by the nearby available-for-landing port search step, and then designating the nearby available-for-landing port extracted by the nearby available-for-landing port search step for the changed route as the alternative candidate port.

The aircraft management system and the aircraft management method described above can prevent a situation in which an alternative landing site cannot be found for an aircraft in flight in the event of a malfunction of the aircraft, bad weather, or other contingent circumstances.

### BRIEF DESCRIPTION OF THE DRAWINGS

FIG. 1 is a block diagram of an aircraft management system;

FIG. 2 is an illustration of a process of changing the route of an aircraft to ensure alternative candidate ports; and

FIG. 3 is a flowchart of an alternative candidate port determination process.

### DETAILED DESCRIPTION OF THE INVENTION

### 1. Configuration of Aircraft Management System

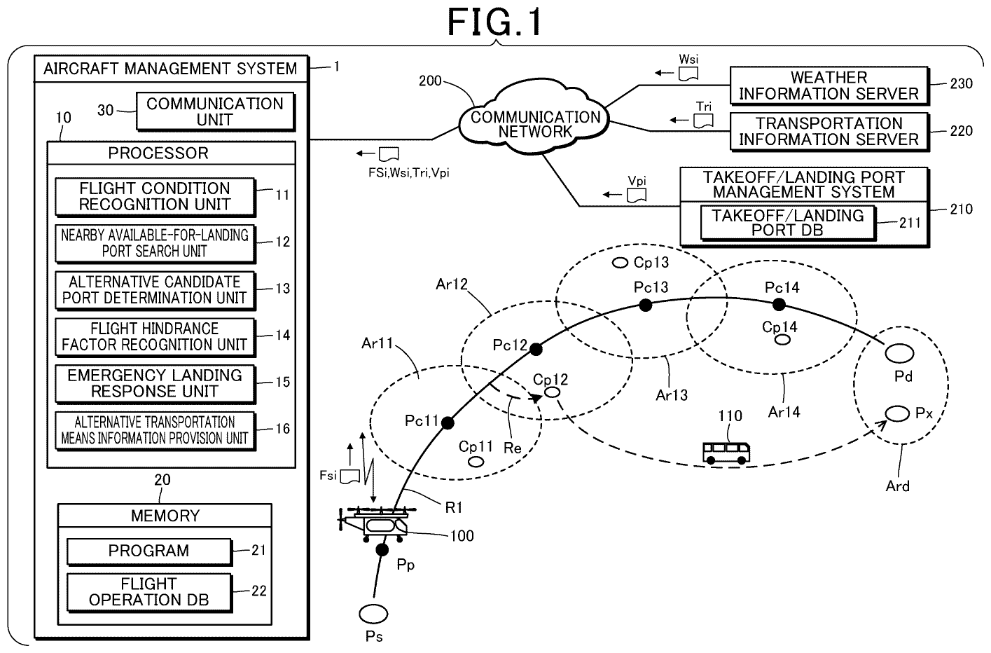

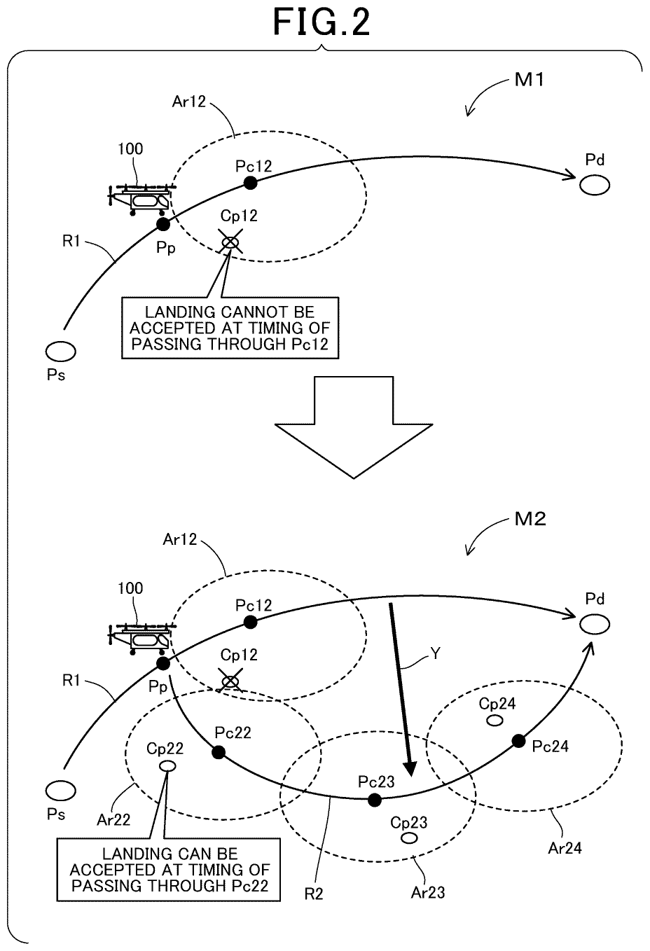

The configuration of an aircraft management system 1 in the present embodiment will be described with reference to FIGS. 1 and 2. Referring to FIG. 1, the aircraft management system 1 monitors the flight condition of an aircraft 100 flying a route R1 from a departure point Ps to a destination point Pd, and executes a process to determine an alternative candidate port for accommodating an emergency landing due to contingent circumstances.

The aircraft 100 is, for example, an electric vertical take-off and landing aircraft (eVTOL). The aircraft management system 1 is a computer system including a processor 10, a memory 20, and a communication unit 30. The processor 10 corresponds to a computer according to this disclosure. The aircraft management system 1 communicates with the aircraft 100, a takeoff/landing port management system 210, a transportation information server 220, and a weather information server 230 via a communication network 200 by means of a communication unit 30.

The takeoff/landing port management system 210 recognizes the usage of a plurality of takeoff/landing ports located in the area to be managed, including the route R1, through communication with a management system placed at each takeoff/landing port, and records usage data indicating the real-time usage of each takeoff/landing port in a takeoff/landing port database (DB) 211 as needed. The weather information server 230 provides weather information for the area to be managed, including the route R1. The transportation information server 220 provides information on transportation operating within the area to be managed, including the route R1.

The memory 20 of the aircraft management system 1 stores a program 21 for controlling the aircraft management system 1 and a flight operation DB 22 that records flight information (flight routes, flight implementation schedules, etc.) for aircrafts managed by the aircraft management system 1 for their operations. By reading and executing the program 21, the processor 10 functions as a flight condition recognition unit 11, a nearby available-for-landing port search unit 12, an alternative candidate port determination unit 13, a flight hindrance factor recognition unit 14, an emergency landing response unit 15, and an alternative transportation means information provision unit 16.

The process performed by the flight condition recognition unit 11 corresponds to the flight condition recognition step in the aircraft management method of the present disclosure, and the process performed by the nearby available-for-landing port search unit 12 corresponds to the nearby available-for-landing port search step in the aircraft management method of the present disclosure. The process performed by the alternative candidate port determination unit 13 corresponds to the alternative candidate port determination step in the aircraft management method of the present disclosure.

The flight condition recognition unit 11 receives flight condition information Fsi transmitted from the aircraft 100 and recognizes the flight condition of the aircraft 100. The flight condition information Fsi includes the route R1 of the aircraft 100 to the destination point Pd, the current position and flight speed of the aircraft 100, the overall condition of the aircraft 100 (the presence or absence of a malfunction and the level of the malfunction if present), the remaining flyable range of the aircraft 100, and the weather in the flight area of the aircraft 100. The flight condition recognition unit 11 records the recognized information on the flight condition of the aircraft 100 in the flight operation DB 22.

The nearby available-for-landing port search unit 12 sets a plurality of check positions Pc11, Pc12, Pc13, and Pc14 that the aircraft 100 will pass based on the route R1 to the destination point Pd, the current position Pp, the flight speed, etc. of the aircraft 100 recognized by the flight condition recognition unit 11, and recognizes a timing at which the aircraft 100 will pass each checkpoint (route passing timing). Then, for each check position, the nearby available-for-landing port search unit 12 searches for a nearby available-for-landing port, which is a takeoff/landing port located within a determination threshold distance from the check position and able to accept landing of the aircraft 100 within a predetermined time (e.g., within tens of minutes to several hours) after the timing at which the aircraft 100 passes the check position.

The nearby available-for-landing port search unit 12 accesses the takeoff/landing port management system 210 and refers to the takeoff/landing port DB 211 to search for a nearby available-for-landing port for each check position. The nearby available-for-landing port search unit 12 may determine whether each takeoff/landing port can accept landing of the aircraft 100 by communicating with the management system placed at the takeoff/landing port to recognize the usage of the takeoff/landing port. FIG. 1 illustrates the case where for check positions Pc11-Pc14, nearby available-for-landing ports Cp11, Cp12, Cp13, and Cp14 are extracted respectively in search areas Ar11-Ar14 within the determination threshold distance.

Here, the check positions are set so that the search areas of adjacent check positions overlap, which ensures that there is always some nearby available-for-landing port within the determination threshold distance from the aircraft 100 while the aircraft 100 is heading toward the destination point Pd. In FIG. 1, four check positions Pc11-Pc14 are shown as an example, but the number of check positions may be changed according to the distance of the route R1, the determination threshold distance, etc. if appropriate.

If a nearby available-for-landing port is extracted by the nearby available-for-landing port search unit 12 for every one of the check positions Pc11-Pc14, the alternative candidate port determination unit 13 designates the extracted nearby available-for-landing ports as alternative candidate ports for emergency landing of the aircraft 100. In contrast, if no nearby available-for-landing port is extracted by the nearby available-for-landing port search unit 12 for any of the check positions, the alternative candidate port determination unit 13 changes the route of the aircraft 100 toward the destination point Pd to a route in which a nearby available-for-landing port is extracted for every one of the check positions.

FIG. 2 illustrates a situation in which, when the aircraft 100 flies the route R1 and approaches the check position Pc12, the nearby available-for-landing port Cp12, which has been designated as an alternative candidate port, becomes unable to accept landing. In this case, the alternative candidate port determination unit 13 changes the route of the aircraft 100 to a route R2 in which a nearby available-for-landing port is extracted by the nearby available-for-landing port search unit 12 for every one of the check positions Pc22, Pc23, and Pc24, as shown by the arrow Y.

In the route R2, nearby available-for-landing ports Cp22, Cp23, and Cp24 are extracted respectively from the search areas Ar22, Ar23, and Ar24 of the check positions Pc22, Pc23, and Pc24, and the alternative candidate port determination unit 13 designates the nearby available-for-landing ports Cp22, Cp23, and Cp24 as alternative candidate ports. This ensures that there is always some alternative candidate port available for landing that is located within the determination threshold distance from the aircraft 100 flying toward the destination point Pd. The alternative candidate port determination unit 13 records information on the changed route in the flight operation DB 22.

The flight hindrance factor recognition unit 14 recognizes flight hindrance factors that hinder the flight of the aircraft 100 to the destination point, such as a malfunction of the aircraft and bad weather, based on flight condition information Fsi transmitted from the aircraft 100 and weather information Wsi transmitted from the weather information server 230 for the areas where the aircraft 100 flies.

When the emergency landing response unit 15 determines that it is difficult for the aircraft 100 to fly to the destination point due to a flight hindrance factor recognized by the flight hindrance factor recognition unit 14, the emergency landing response unit 15 changes the route to an emergency route to the nearest alternative candidate port from the current position of the aircraft and transmits emergency response information indicating landing at the alternative candidate port. This makes it possible to quickly arrange a response for emergency landing at an alternative candidate port when a contingent flight hindrance factor happens to the aircraft 100.

When the route of aircraft 100 is changed to an emergency route to an alternative candidate port by the emergency landing response unit 15, the alternative transportation means information provision unit 16 accesses the transportation information server 220 to obtain transportation information Tri, thereby searching for an alternative transportation means to travel from the alternative candidate port to the vicinity of the destination point. The alternative transportation means information provision unit 16 then provides the passengers of the aircraft 100 with information on alternative transportation means available to travel from the alternative candidate port to the vicinity of the destination point.

FIG. 1 illustrates the case where the route R1 of the aircraft 100 is changed to an emergency route Re to a nearby available-for-landing port Cp12 that is designated as an alternative candidate port. In this case, the alternative transportation means information provision unit 16 transmits to mobile terminals used by the passengers, for example, information on the ground transportation means 110 from the nearby available-for-landing port Cp12 to a predetermined point Px in the area Ard including the destination point Pd. The ground transportation means 110 is public transportation such as buses, trains, and shared vehicles. In addition to the ground transportation means, information on an alternative flight that can be arranged may be transmitted to the mobile terminals as the information on alternative transportation means.

### 2. Alternative Candidate Port Determination Process

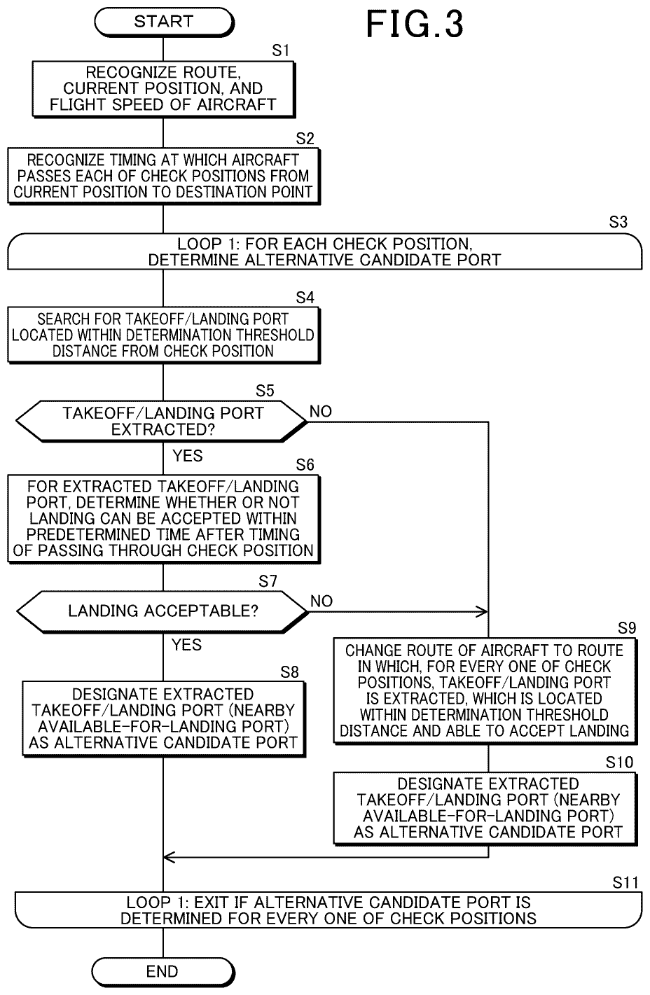

The procedure of an alternative candidate port determination process performed by the aircraft management system 1 for the aircraft 100 in flight shown in FIG. 1 is described according to the flowchart shown in FIG. 3. The aircraft management system 1 repeatedly executes the process according to the flowchart shown in FIG. 3 with a predetermined control cycle while the aircraft 100 is flying toward the destination point Pd.

In step S1 in FIG. 3, the flight condition recognition unit 11 receives flight condition information Fsi transmitted from the aircraft 100 and recognizes the route, current position, and flight speed of the aircraft 100. In the following step S2, the nearby available-for-landing port search unit 12 recognizes a timing at which the aircraft 100 passes each of the check positions Pc11-Pc14 set in the route R1 from the departure point Ps to the destination point Pd of the aircraft 100.

The loop process of the subsequent steps S3-S11 determines an alternative candidate port to accommodate an emergency landing for each of the check positions Pc11-Pc14 or, if the route of the aircraft 100 is changed, for each new check position after the change. In the following, a check position being processed by steps S4-S8 is referred to as a target check position.

In step S4, the nearby available-for-landing port search unit 12 refers to the takeoff/landing port DB 211 of the takeoff/landing port management system 210 to search for a nearby available-for-landing port located within the determination threshold distance from the target check position. Then, the nearby available-for-landing port search unit 12 advances the process to step S6 if a takeoff/landing port located within the determination threshold distance from the target check position is extracted, or to step S9 if no takeoff/landing port located within the determination threshold distance from the target check position is extracted. If the route of the aircraft 100 to the destination point has been determined so that a takeoff/landing port is located within the determination threshold distance from each check position, the processes in steps S4 and S5 can be omitted.

In step S6, the nearby available-for-landing port search unit 12 refers to the takeoff/landing port DB 211 to determine whether the extracted takeoff/landing port is able to accept landing of the aircraft 100. In the following step S7, the nearby available-for-landing port search unit 12 advances the process to step S8 if the extracted takeoff/landing port is able to accept landing (i.e., if a nearby available-for-landing port is extracted), or step S9 if the extracted takeoff/landing port is not able to accept landing.

In step S8, the alternative candidate port determination unit 13 designates the takeoff/landing port (nearby available-for-landing port) extracted by the nearby available-for-landing port search unit 12 as an alternative candidate port for an emergency landing. In step S9, the alternative candidate port determination unit 13 changes the route of the aircraft 100 to a route in which, for every one of the check positions, the nearby available-for-landing port search unit 12 extracts a takeoff/landing port (nearby available-for-landing port) located within the determination threshold distance from the check position and able to accept landing of the aircraft 100, as described above in reference to FIG. 2.

In the following step S10, the alternative candidate port determination unit 13 designates the nearby available-for-landing ports extracted for the changed route as alternative candidate ports for an emergency landing. If the alternative candidate port determination unit 13 changes the route of the aircraft 100 by the process in step S9, the alternative candidate port determination unit 13 transmits route change information indicating the route change to the aircraft 100 to instruct the aircraft 100 to change its route.

After the route of the aircraft 100 is changed in step S9, the aircraft management system 1 executes the process according to the flowchart in FIG. 3 for the changed route. This makes it possible to further change the route when nearby available-for-landing ports for the changed route are no longer extracted adequately, so as to ensure that there is always some alternative candidate port within the determination threshold distance from the current position of the aircraft 100 flying toward the destination point Pd.

### 3. Alternative Embodiments

In the above embodiment, if the aircraft 100 continues to fly to the destination point Pd when a malfunction of the aircraft occurs because the level of the malfunction is less severe than the level at which the emergency landing response unit 15 determines that it is difficult to fly to the destination, the nearby available-for-landing port search unit 12 may change the determination threshold distance for searching for nearby available-for-landing ports according to the level of the malfunction recognized by flight condition recognition unit 11 based on flight condition information Fsi. For example, the higher the level of the malfunction is (the greater the impact on the flight of the aircraft 100 is), the shorter the determination threshold distance may be.

In the above embodiment, the nearby available-for-landing port search unit 12 may change the determination threshold distance for searching for nearby available-for-landing ports according to the remaining flyable range of the aircraft 100 recognized by the flight condition recognition unit 11. For example, if the remaining flyable range of the aircraft 100 is sufficiently long, the determination threshold distance may be increased. The remaining flyable range of the aircraft 100 is recognized based on the amount of remaining energy (such as fuel and electricity stored in batteries) to drive the aircraft 100, weather, etc.

In the above embodiment, the aircraft management system of the present disclosure is configured by using the aircraft management system 1, which is a computer system communicating with the aircraft 100, but the aircraft management system of the present disclosure may be configured to be installed on the aircraft 100. In this case, the aircraft management system on the aircraft 100 is configured to communicate with the takeoff/landing port management system or a management system placed at each takeoff/landing port to search for nearby available-for-landing ports. Part of the configuration of the aircraft management system 1 may also be configured to be provided on the aircraft 100.

FIG. 2 is a schematic diagram illustrating the functional configuration of the aircraft management system 1 divided according to the main processing features, to facilitate understanding of the present invention, but the configuration of the aircraft manager system 1 may be divided in different ways. The processing of each component may be performed by a single hardware unit or by a plurality of hardware units. The processing by each component shown in FIG. 3 may be performed by a single program or by a plurality of programs.

### 4. Configurations Supported by Above Embodiments

The above embodiments are examples of the following configurations.
(Configuration 1) An aircraft management system, comprising: a flight condition recognition unit configured to recognize a flight condition of an aircraft flying a route to a destination point; a nearby available-for-landing port search unit configured to recognize a route passing timing, which is a timing at which the aircraft flies the route, based on a result of recognizing the flight condition of the aircraft by the flight condition recognition unit, and to search for a nearby available-for-landing port, which is a takeoff/landing port located within a predetermined determination threshold distance from the route and able to accept a landing within a predetermined time after the route passing timing; and an alternative candidate port determination unit configured to, if the nearby available-for-landing port is extracted by the nearby available-for-landing port search unit, designate the extracted nearby available-for-landing port as an alternative candidate port for accommodating an emergency landing of the aircraft, or to, if the nearby available-for-landing port is not extracted by the nearby available-for-landing port search unit, change the route of the aircraft to the destination point to a route in which a nearby available-for-landing port is extracted by the nearby available-for-landing port search unit, and then designate the nearby available-for-landing port extracted by the nearby available-for-landing port search unit for the changed route as the alternative candidate port.

With the aircraft management system in configuration 1, for an aircraft flying a route to a destination point, a route passing timing at which the aircraft flies the route is recognized, and a nearby available-for-landing port is searched for, which is located within a determination threshold distance from the route and able to accept a landing within a predetermined time after the route passing timing. If the nearby available-for-landing port is extracted, the nearby available-for-landing port is designated as an alternative candidate port for accommodating an emergency landing, or if no nearby available-for-landing port is extracted, the route of the aircraft is changed to a route in which a nearby available-for-landing port is extracted. This ensures that there is always some alternative candidate port for the aircraft in flight, and thus can prevent a situation in which an alternative landing site cannot be found for the aircraft in flight in the event of a malfunction of the aircraft, bad weather, or other contingent circumstances.
(Configuration 2) The aircraft management system according to configuration 1, wherein the flight condition recognition unit is configured to repeatedly perform a process of recognizing the flight condition of the aircraft during a flight of the aircraft, the nearby available-for-landing port search unit is configured to repeatedly perform a process of searching for a nearby available-for-landing port based on a result of recognizing the flight condition of the aircraft by the flight condition recognition unit, and the alternative candidate port determination unit is configured to repeatedly perform a process of determining the alternative candidate port based on whether or not the nearby available-for-landing port is extracted by the nearby available-for-landing port search unit.

With the aircraft management system in configuration 2, by repeatedly performing the process of searching for a nearby available-for-landing port as the aircraft flies, the alternative candidate port can be updated in response to changes in the flight condition of the aircraft or in the case where the takeoff/landing port that has been designated as the alternative candidate port becomes unable to accept a landing.
(Configuration 3) The aircraft management system according to configuration 1 or configuration 2, wherein the flight condition recognition unit is configured to recognize the flight condition including a level of a malfunction occurring in the aircraft, and the nearby available-for-landing port search unit is configured to change the determination threshold distance according to the level of the malfunction occurring in the aircraft recognized by the flight condition recognition unit.

With the aircraft management system in configuration 3, an alternative candidate port available for an emergency landing can be determined according to the level of a malfunction occurring in the aircraft.
(Configuration 4) The aircraft management system according to any one of configurations 1 to 3, wherein the flight condition recognition unit is configured to recognize the flight condition including a remaining flyable range of the aircraft, and the nearby available-for-landing port search unit is configured to change the determination threshold distance according to the remaining flyable range of the aircraft recognized by the flight condition recognition unit.

With the aircraft management system in configuration 4, an alternative candidate port available for an emergency landing can be determined according to the remaining flyable range of the aircraft.
(Configuration 5) The aircraft management system according to any one of configurations 1 to 4, comprising: a flight hindrance factor recognition unit configured to recognize presence or absence of a flight hindrance factor that hinders a flight of the aircraft to the destination point; and an emergency landing response unit configured to change the route of the aircraft to an emergency route to the alternative candidate port when the presence of the flight hindrance factor is recognized by the flight hindrance factor recognition unit.

With the aircraft management system in configuration 5, even when a flight hindrance factor of the aircraft occurs, a safe flight can be ensured for the aircraft by changing the route of the aircraft to an emergency route to an alternative candidate port.
(Configuration 6) The aircraft management system according to any one of configurations 1 to 5, comprising: an alternative transportation means information provision unit configured to provide information on alternative transportation means to travel from the alternative candidate port to a predetermined area in which the destination point is located, if the route of the aircraft is changed to an emergency route by the emergency landing response unit.

With the aircraft management system in configuration 6, when the aircraft lands at an alternative candidate port different from the original destination point, the use or arrangements of alternative transportation means to travel to the vicinity of the destination point can be supported by providing information on alternative transportation means to mobile terminals used by the passengers of the aircraft or the management system of the transportation company operating the aircraft.
(Configuration 7) An aircraft management method executed by a computer, comprising: a flight condition recognition step of recognizing a flight condition of an aircraft flying a route to a destination point; a nearby available-for-landing port search step of recognizing a route passing timing, which is a timing at which the aircraft flies the route, based on a result of recognizing the flight condition of the aircraft by the flight condition recognition step, and searching for a nearby available-for-landing port, which is a takeoff/landing port located within a predetermined determination threshold distance from the route and able to accept a landing within a predetermined time after the route passing timing; and an alternative candidate port determination step of, if the nearby available-for-landing port is extracted by the nearby available-for-landing port search step, designating the extracted nearby available-for-landing port as an alternative candidate port for accommodating an emergency landing of the aircraft, or, if the nearby available-for-landing port is not extracted by the nearby available-for-landing port search step, changing the route of the aircraft to the destination point to a route in which a nearby available-for-landing port is extracted by the nearby available-for-landing port search step, and then designating the nearby available-for-landing port extracted by the nearby available-for-landing port search step for the changed route as the alternative candidate port.

By executing the aircraft management method in configuration 7 by a computer, the same effect as the aircraft management system in configuration 1 can be achieved.

1 . . . aircraft management system, 10 . . . processor, 11 . . . flight condition recognition unit, 12 . . . nearby available-for-landing port search unit, 13 . . . alternative candidate port determination unit, 14 . . . flight hindrance factor recognition unit, 15 . . . emergency landing response unit, 16 . . . alternative transportation means information provision unit, 20 . . . memory, 21 . . . program, 22 . . . flight operation DB, 30 . . . communication unit, 100 . . . aircraft, 110 . . . alternative transportation means, 200 . . . communication network, 210 . . . takeoff/landing port management system, 211 . . . takeoff/landing port DB, 220 . . . transportation information server, 230 . . . weather information server.

1. An aircraft management system, comprising:
a flight condition recognition unit configured to recognize a flight condition of an aircraft flying a route to a destination point;
a nearby available-for-landing port search unit configured to recognize a route passing timing, which is a timing at which the aircraft flies the route, based on a result of recognizing the flight condition of the aircraft by the flight condition recognition unit, and to search for a nearby available-for-landing port, which is a takeoff/landing port located within a predetermined determination threshold distance from the route and able to accept a landing within a predetermined time after the route passing timing; and
an alternative candidate port determination unit configured to, if the nearby available-for-landing port is extracted by the nearby available-for-landing port search unit, designate the extracted nearby available-for-landing port as an alternative candidate port for accommodating an emergency landing of the aircraft, or to, if the nearby available-for-landing port is not extracted by the nearby available-for-landing port search unit, change the route of the aircraft to the destination point to a route in which a nearby available-for-landing port is extracted by the nearby available-for-landing port search unit, and then designate the nearby available-for-landing port extracted by the nearby available-for-landing port search unit for the changed route as the alternative candidate port.

2. The aircraft management system according to claim 1, wherein
the flight condition recognition unit is configured to repeatedly perform a process of recognizing the flight condition of the aircraft during a flight of the aircraft,
the nearby available-for-landing port search unit is configured to repeatedly perform a process of searching for a nearby available-for-landing port based on a result of recognizing the flight condition of the aircraft by the flight condition recognition unit, and
the alternative candidate port determination unit is configured to repeatedly perform a process of determining the alternative candidate port based on whether or not the nearby available-for-landing port is extracted by the nearby available-for-landing port search unit.

3. The aircraft management system according to claim 1, wherein
the flight condition recognition unit is configured to recognize the flight condition including a level of a malfunction occurring in the aircraft, and
the nearby available-for-landing port search unit is configured to change the determination threshold distance according to the level of the malfunction occurring in the aircraft recognized by the flight condition recognition unit.

4. The aircraft management system according to claim 1, wherein
the flight condition recognition unit is configured to recognize the flight condition including a remaining flyable range of the aircraft, and
the nearby available-for-landing port search unit is configured to change the determination threshold distance according to the remaining flyable range of the aircraft recognized by the flight condition recognition unit.

5. The aircraft management system according to claim 1, comprising:
a flight hindrance factor recognition unit configured to recognize presence or absence of a flight hindrance factor that hinders a flight of the aircraft to the destination point; and
an emergency landing response unit configured to change the route of the aircraft to an emergency route to the alternative candidate port when the presence of the flight hindrance factor is recognized by the flight hindrance factor recognition unit.

6. The aircraft management system according to claim 5, comprising
an alternative transportation means information provision unit configured to provide information on alternative transportation means to travel from the alternative candidate port to a predetermined area in which the destination point is located, if the route of the aircraft is changed to the emergency route by the emergency landing response unit.

7. An aircraft management method executed by a computer, comprising:
a flight condition recognition step of recognizing a flight condition of an aircraft flying a route to a destination point;
a nearby available-for-landing port search step of recognizing a route passing timing, which is a timing at which the aircraft flies the route, based on a result of recognizing the flight condition of the aircraft by the flight condition recognition step, and searching for a nearby available-for-landing port, which is a takeoff/landing port located within a predetermined determination threshold distance from the route and able to accept a landing within a predetermined time after the route passing timing; and
an alternative candidate port determination step of, if the nearby available-for-landing port is extracted by the nearby available-for-landing port search step, designating the extracted nearby available-for-landing port as an alternative candidate port for accommodating an emergency landing of the aircraft, or, if the nearby available-for-landing port is not extracted by the nearby available-for-landing port search step, changing the route of the aircraft to the destination point to a route in which a nearby available-for-landing port is extracted by the nearby available-for-landing port search step, and then designating the nearby available-for-landing port extracted by the nearby available-for-landing port search step for the changed route as the alternative candidate port.
